(19) United States
(12) Patent Application Publication
(10) Pub. No.: US 2008/0310753 A1
(43) Pub. Date: Dec. 18, 2008

(54) Method and system to detect and correct shine

(76) Inventor: Albert D. Edgar, Austin, TX (US)

Correspondence Address: Image Trends, Inc., Building One, Suite 450, 6300 Bridgepoint Parkway, Austin, TX, 78730, US

(21) Appl. No.: 12/157,735

(22) Filed: Jun. 12, 2008

Related U.S. Application Data
(60) Provisional application No. 60/934,283, filed on Jun. 12, 2007.

(51) Int. Cl. G06K 9/40

(52) U.S. Cl. 382/274

(57) ABSTRACT

A method and system to detect and correct shine within a digital image is disclosed. Many images would be more aesthetically pleasing if the shine, or reflectance, from was reduced. In one embodiment of the present invention, shine on the skin of a individual in a digital image is reduced to a more aesthetically pleasing level. In this embodiment, the image is first analyzed to determine the areas of skin. The skin areas are then analyzed to determine the intensity of shine on the skin and create a shine mask. The shine mask is then used to correct the shine by adjusting the shine to a more aesthetically pleasing level.

### CROSS REFERENCE TO RELATED APPLICATIONS

This application claims priority under 35 U.S.C. 119(e) to U.S. Provisional Patent Application No. 60/934,283, entitled Method and System to Detect and Correct Shine, having a priority filing date of Jun. 12, 2008.

### FIELD OF THE INVENTION

This invention generally relates to digital imaging and more specifically to a method and system to detect and correct shine.

### BACKGROUND OF THE INVENTION

The photography market has exploded with the wide adoption of digital imaging in traditional cameras, mobile phones and video cameras. These digital cameras accurately capture the moment, but also capture certain unwanted detail that users would like to correct to a more desirable level. One consistent problem is the light reflecting from an object or person in a photograph, which for purposes of this patent will be referred to as “shine.” An example of shine familiar to most people is the shiny reflection of light from the forehead of someone in the picture. In many cases, the shine makes the image unusable.

Conventional methods of reducing shine are generally attempted when the image is taken. For example, the photographer will vary the light to reduce shine or apply cosmetic powders to reduce the reflectance of the surface. These methods are typically effective only in staged images where the photographer has plenty of time to position the subjects and lighting in the image.

Once the image has been taken, shine is typically corrected by manually “touching-up” the image using one of many conventional photo editing software solutions. In short, the operator views the image and manually defines each area that is shiny. Using brushes or fill techniques, the operator then corrects the shiny area. This manual editing technique is time consuming and often leads to blended patches that detract from the quality of the image.

Conventional solutions for correcting shine in an image are generally expensive, difficult and cannot be applied to most images. Accordingly, a method and system for correcting shine to create a more appealing image is needed.

### SUMMARY OF THE INVENTION

The present invention provides a method and system to automatically detect and correct shine within an image. The present invention is described in terms of detecting and correcting shine from human skin, but the scope of this invention should not be limited to this embodiment. The teachings of this invention can be applied to other surfaces, including organic materials like trees and plants, to metals, plastics and other inorganic materials that have varying reflective properties.

In one implementation of the present invention, a method for correcting shine in an image is provided. In this implementation, the image is analyzed to determine the characteristics of human skin. A shine mask that defines the areas of shine is then calculated based on the intensity of white, green, blue and red color spaces on skin. In a particular implementation, the intensity of the shine within each area of the shine mask is also determined. The shine mask is then used to correct the shine within the image. As used herein, “correct” shall mean that the shine is adjusted to a more visually appealing level. The correction can be an adjustment of the image properties (luminance, color, hue, etc.) within all or a portion of the shine mask area. In the preferred embodiment, the intensity of the shine is reduced by adjusting the color space levels within the shine mask.

At least one embodiment of this invention has the advantage of automatically detecting varying levels of shine and correcting the shine within the image. This results in images that are more visually appealing. Other advantages will be readily apparent to one skilled in the art from the following figures, descriptions, and claims.

### BRIEF DESCRIPTION OF THE DRAWINGS

For a more complete understanding of the invention and the advantages thereof, reference is now made to the following description taken in conjunction with the accompanying drawings, wherein like reference numerals represent like parts, in which:

FIGS. 1A-1C are schematic diagrams of electronic systems in accordance with particular embodiments of the present invention;

FIG. 2 is a flow chart of a method for correcting shine on skin within an original image in accordance with one embodiment of the invention; and

FIG. 3 is a flow chart of a method for correcting shine on skin within an original image in accordance with another embodiment of the present invention.

### DETAILED DESCRIPTION OF THE PREFERRED EMBODIMENTS

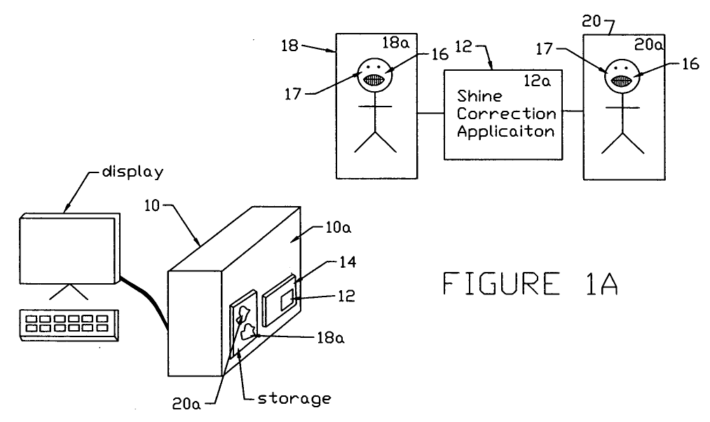

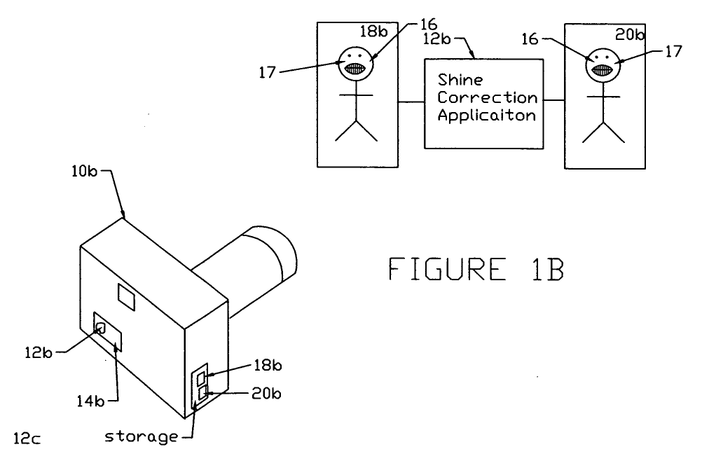

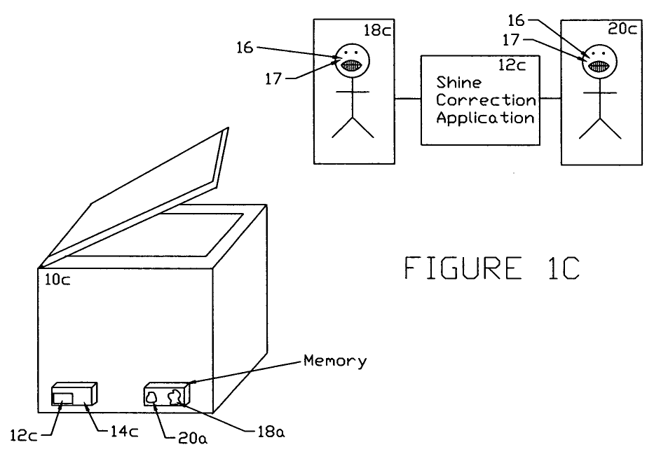

The preferred embodiment of the present invention and its advantages are best understood by referring to FIGS. 1-3, wherein like numerals are used for like and corresponding parts in the various drawings.

FIGS. 1A-1C illustrate certain electronic systems 10 that utilize a shine correction application 12 running on one or more processors 14 to detect and adjust the shine 16 on the skin 17 within an original image 18 and produce a corrected image 20. In the preferred embodiment, the shine 16 is reduced without appearing unnatural and losing image detail. The shine correction application 12 may also include other image correction/management functionality, such as resize, color management, format and other such functionality without departing from the scope and spirit of the present invention.

FIG. 1A illustrates a computer electronic system 10a. In this embodiment, the computer electronic system 10a includes one or more processors 14a. A shine correction application 12a is loaded into the computer electronic system 10a and runs on the processors 14a. The shine correction application 12a operates to receive an original image 18a from a source, such as a removable media drive, external imaging system, storage system or other such device (not shown). The shine correction application 12a operates to detect the reflective shine 16 on the skin 17 of subjects within the original image 18a. The shine correction application 12a reduces the shine 17 and produces a corrected image 20a. The corrected image 20a can then be exported, displayed or stored.

FIG. 1B illustrates a camera electronic system 10b. In this embodiment, the camera electronic system 10b includes one or more processors 14b. A shine correction application 12b is loaded into the camera electronic system 10b and runs on the processors 14b. In this embodiment, the shine correction application 12b is generally optimized to operate on processors 14b having comparably low processing power. The shine correction application 12b operates to receive an original image 18b directly from the camera's optical sensor (not shown) or storage device (not shown) within the camera electronic system 10b. The shine correction application 12b operates to detect shine 16 on the skin 17 of one or more subjects within the original image 18b. The shine correction application 12b reduces the shine 16 on the skin 17 and produces a corrected image 20b. The corrected image 20b can then be exported, displayed or stored.

FIG. 1C illustrates a scanner electronic system 10c, such as a flatbed scanner, copy machine, fax or other such scanning device. In this embodiment, the scanner electronic system 10c includes one or more processors 14c. A shine correction application 12c is loaded into the scanner electronic system 10c and runs on the processors 14c. The shine correction application 12c operates to receive an original image 18c directly from the scanner's optical sensor (not shown) or storage device (not shown) within the scanner electronic system 10c. The shine correction application 12c operates to detect the shine 16 on the skin 17 of one or more subjects within within the original image 18c. The shine correction application 12c reduces the shine 16 on the skin 17 and produces a corrected image 20c. The corrected image 20c can then be exported, displayed or stored.

It will be understood that the electronic systems 10 may comprise any suitable device or system for running the shine correction application 12. It should also be understood that the electronic systems 10 may include other components and devices without departing from the scope and spirit of the present invention.

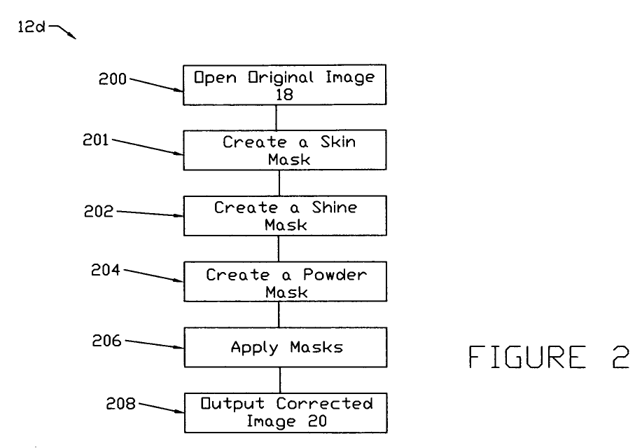

FIG. 2 is a flow chart of a shine correction application 12d in accordance with one embodiment of the present invention. In this embodiment, the shine correction application 12d comprises the steps of opening the original image (18) 200, creating a shine mask 202, creating a powder masks 204; applying the masks 206 and outputting the corrected image (20) 208.

In step 200, the original image 18 is received and opened by the shine correction application 12d. In the preferred embodiment, the original image 18 is a color digital image with a suitable resolution. As illustrated in FIGS. 1A-1C, the original image 18 may be received from any suitable device, system or storage system.

In step 201, a skin mask is created. In one embodiment, the original image 18 is analyzed to determine the areas of the skin 17. Skin 17 has the spectral qualities of hemoglobin and the method looks for various frequency ranges of red in a form that typically represents human skin 17 to identify which areas of the original image 18 are skin 17.

In step 202, a shine mask is created. In one embodiment, the areas defined by the skin mask are analyzed to determine the areas of the skin 17 that show shine 16, or reflection, from such items as camera flash, normal room lighting, sunlight and other light sources that may produce a shine or glare on the skin. For example, skin that is sweaty or oily will exhibit more of a shine effect than skin that is dry and cosmetically altered. In the preferred embodiment, a map of the skin 17 is created. A map of the shine 16 on the skin 17 is created by correlating intense areas of ‘red’, ‘green’, and ‘blue’ shine on the skin.

In step 204, a powder mask is created. In one embodiment, the powder mask is created by blurring of the color channels to reduce reflection. This produces an effect similar to applying cosmetic powder to the skin 17 to reduce shine 16.

In step 206, the masks from steps 202 and 204 are applied to the original image 18 to produce the corrected image 20. In the preferred embodiment, the shine mask defines the areas of the powder mask to be applied to the original image 18.

In step 208, the corrected image 20 is output to a location selected by the user, such as a display, storage device or other system.

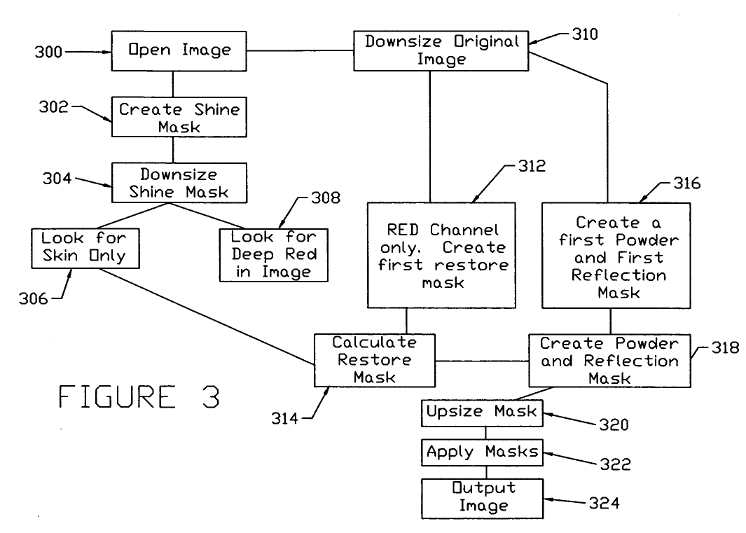

FIG. 3 is a flow chart of a shine correction application 12e in accordance with another embodiment of the present invention. In this embodiment, the shine correction application 12e utilizes downsizing to improve processing efficiency.

In step 300, the original image 18 is opened by the shine correction application 12e. In step 302, a shine mask is created. In one embodiment, shine 16 is detected using frequency information in the ‘red’, ‘green’, and ‘blue’ color channels of the original image 18, but is not limited to RGB color space. The frequency information is analyzed to search for correlated intense areas of ‘red’, ‘green’, and ‘blue’ shine 16 on the skin 17. The detected areas become a mask for the next processing steps. In step 304, the shine mask is downsized for processing efficiency.

In step 306, the shine areas are analyzed to determine the areas of skin 17. Skin 17 has the spectral qualities of hemoglobin and the method looks for various frequency ranges of red in a form that typically represents human skin 17 to identify which areas of the shine mask are located on skin 17. In step 308, a deep red mask is created. In one embodiment, the skin mask and deep red mask utilize of a combination of median filters, Gaussian filters, and gamma correction to create the masks.

In step 310, in parallel with creating the shine mask in step 302, the original image 18 is downsized. In step 312, a preliminary restore mask is created using the downsized image from step 310 and the deep red mask from step 308. In step 314, a restore mask is calculated from the preliminary restore mask and the skin only mask calculated in step 306 using inversion, mixing, and blurring.

In step 316, a preliminary powder mask and preliminary reflection mask are calculated from the downsized original image of step 310. These masks are calculated using inversion, mixing, and blurring. In step 318, the preliminary powder and reflection masks are used in conjunction with the ‘restore mask’ calculated in step 314 to create the ‘powder mask’ and ‘reflection mask’.

In step 320, the reflection mask calculated in step 318 is upsized. In step 322, the masks are applied. Specifically, the upsized reflection mask is used in conjunction with the original ‘no-shine’ image to create an RGB image in which the ‘red’ contains the final output. In addition, the green and blue channels are used in conjunction with the ‘powder mask’ image to create the final ‘green’ and ‘blue’ channels without shine. These combined channels constitute the corrected image 20. In step 324, the corrected image 20 is output to any suitable display, device, storage or network as stipulated by the user.

Throughout the description and claims of this specification the word “comprise” and variation of that word, such as “comprises” and “comprising”, are not intended to exclude other additives, components, integers or steps. While the invention has been particularly shown and described in the foregoing detailed description, it will be understood by those skilled in the art that various other changes in form and detail may be made without departing from the spirit and scope of the invention as set forth in the appended claims.

What is claimed is:

1. A shine correction application operable to be loaded into an electronic system, wherein the shine correction application operates to:
receive an original image;
determine the areas of the original image that have skin tones;
determine the areas of the original image that have shine;
reduce the shine on areas of skin to create a corrected image that is more visually appealing than the original image; and
outputting the corrected image.

2. The shine correction application of claim 1, wherein the shine correction application utilizes downsizing to increase processing efficiency.

3. The shine correction application of claim 1, wherein the areas of the original image having skin tones is calculated by matching colors that correspond to the spectral qualities of hemoglobin.

4. The shine correction application of claim 1, wherein determining the areas of shine in the original image is limited to the areas having skin tones.

5. The shine correction application of claim 1, wherein determining the areas of skin tones in the original image is limited to the areas having shine.

6. The shine correction application of claim 1, wherein the shine is reduced by applying a powder mask.

7. The shine correction application of claim 6, wherein reducing the shine to create a corrected image comprises creating a red-green-blue (RGB) image in which the red channel contains the original red channel and the powder mask is applied to the green and blue channels.

8. An electronic system comprising:
one or more processors;
a shine correction application operable to be loaded into the processors, wherein the shine correction application operates to:
receive an original image;
determine the areas of the original image that have skin tones;
determine the areas of the original image that have shine;
reduce the shine on areas of skin to create a corrected image that is more visually appealing than the original image; and
outputting the corrected image.

9. The electronic system of claim 8, wherein the areas of the original image having skin tones is calculated by matching colors that correspond to the spectral qualities of hemoglobin.

10. The electronic system of claim 8, wherein determining the areas of shine in the original image is limited to the areas having skin tones.

11. The electronic system of claim 8, wherein the shine is reduced by applying a powder mask.

12. The electronic system of claim 11, wherein reducing the shine to create a corrected image comprises creating a red-green-blue (RGB) image in which the red channel contains the original red channel and the powder mask is applied to the green and blue channels.

13. The electronic system of claim 1, wherein the electronic system is a computer electronic system.

14. A method for reducing shine within an original image comprising the steps of:
calculating the areas of the original image that correlate to skin;
calculating the areas of the original image that have shine; and
reducing the shine in at least one area having shine to create a corrected image that is more visually appealing than the original image.

15. The method of claim 14, wherein the step of calculating the areas that correlate to skin comprises calculating the areas of the original image that correlate to skin based on the spectral qualities of hemoglobin.

16. The method of claim 14, wherein the step of calculating the areas of shine in the original image is limited to the areas of skin.

17. The method of claim 14, wherein the shine is reduced by applying a powder mask.

18. The method of claim 17, wherein reducing the shine to create a corrected image comprises creating a red-green-blue (RGB) image in which the red channel contains the original red channel and the powder mask is applied to the green and blue channels.
